(19) United States
(12) Patent Application Publication
(10) Pub. No.: US 2026/0259390 A1
(43) Pub. Date: Sep. 3, 2026

(54) FLEXURE FOR MIRROR ADJUSTMENT

(71) Applicant: TAARA CONNECT, INC., Sunnyvale, CA (US)

(72) Inventors: Yuma Ohkura, San Mateo, CA (US); Markus DeMartini, Auburn, CA (US); Andrei Kazmierski, Pleasanton, CA (US)

(21) Appl. No.: 19/535,117

(22) Filed: Feb. 10, 2026

Related U.S. Application Data
(60) Provisional application No. 63/764,901, filed on Feb. 28, 2025.

(51) Int. Cl. G02B 7/182; B60R 1/072; G02B 26/08; H04B 10/071; H04B 10/40

(52) U.S. Cl. CPC G02B 7/1825; B60R 1/072; G02B 26/0825; G02B 26/0841; H04B 10/071; H04B 10/40

(57) ABSTRACT

Aspects of the technology relates to alignment of components of an optical communications terminal. Specifically, alignment of a mirror (e.g., steering mirror) with other components of the optical communications terminal using a flexure connected thereto. The flexure may be configured to expand and contract allowing for adjustment of tip and tilt of the mirror. The mirror in conjunction with other components of the optical communications terminal may be configured to transmit and receive signals or beams (e.g., optical communications signals or beams) with remote terminals.

### A CROSS REFERENCE TO RELATED APPLICATIONS

The present application claims the benefit of the filing date of U.S. Provisional Application No. 63/764,901, filed February 28, 2025, the entire disclosure of which is incorporated by reference herein.

### BACKGROUND

Wireless optical communication enables high-throughput and long-range communication, in part due to high gain offered by the narrow angular width of the transmitted beam. However, the narrow beam also requires that it must be accurately and actively pointed in order to remain aligned to an aperture of a communications terminal at the remote end. This pointing may be accomplished by small mirrors (e.g., microelectromechanical systems or voice-coil based fast-steering mirror mechanisms) that are actuated to steer the beam. In other implementations, electrically controllable steering of beams with no moving parts is used to steer the beam, which provides cost, lifetime and performance advantages. Optical Phased Arrays (OPAs) are a critical technology component, with added benefits of adaptive-optics, point-to-multipoint support, and mesh network topologies. Each active element in the OPA requires electrically controllable shifting capability.

### BRIEF SUMMARY

Aspects of the disclosure provide a system for adjustment a mirror of an optical communications terminal, the system comprising: a mirror configured to direct optical signals between an aperture of the optical communications terminal and an optical phased array (OPA) of an optical communications terminal; and a flexure configured to receive the mirror. The flexure comprising: an outer portion, one or more inner portions, and one or more discontinuities delineating the one or more inner portions and the outer portion, wherein the one or more discontinuities allow for expansion and contraction of the flexure by movement of the one or more inner portions of the flexure relative to the outer portion of the flexure, wherein expansion and contraction of the flexure allows for adjustment of the mirror.

In one example, the system further includes a movable support structure attached to the flexure and configured to receive the mirror; and one or more fasteners configured to attach the movable support structure to a housing of the optical communications terminal, the one or more fasteners being further configured to be adjusted by tightening and loosening, wherein the adjustment of the one or more fasteners allows for expansion and contraction of the flexure. Additionally, the system may further include a plurality of springs attached to the movable support structure and the housing of the optical communications terminal, wherein the plurality of springs is kept in tension. Additionally, the tension of the plurality of springs may allow the movable support structure to be kept in tension; and the tension of the plurality of springs and the movable support structure may prevent the flexure from expanding or compressing unless the one or more fasteners are tightened or loosened. Additionally or alternatively, the system may further include a back plate configured to secure the mirror to the movable support structure and the flexure.

In another example, the adjustment of the mirror using the flexure is conducted during manufacture of the optical communications terminal.

In an additional example, the system further includes a heat path operatively connected to the mirror, the heat path allowing for downstream dispersal of excess heat from the mirror.

In another example, the flexure expands and contracts in the z direction. In a further example, the one or more discontinuities form a spiral shape. In an additional example, the one or more discontinuities form a circular shape. In another example, the one or more discontinuities form a rectangular shape.

In a further example, one of the one or more discontinuities includes a first end located at or adjacent to a connection point between the outer portion of the flexure and the one or more inner portions of the flexure.

In an additional example, wherein the one or more inner portions includes a first inner portion and a second inner portion separated by at least one of the one or more discontinuities. Additionally, the second inner portion may be configured to move relative to the first inner portion and the outer portion during expansion and the contraction of the flexure.

In another example, the one or more inner portions are configured to move away from the outer portion during expansion. In a further example, the one or more inner portions are configured to move towards the outer portion during contraction.

Another aspect of the disclosure is directed towards a method of adjusting a mirror of an optical communications terminal, the method comprising: measuring, by one or more receiver components of the optical communications terminal, at least one of power and intensity of a received optical beam; and upon determining the measured at least one of the power and the intensity is not a maximum power or intensity associated with the optical beam, adjusting one or more fasteners resulting in expansion or contraction of a flexure connected to the mirror of the optical communications terminal, the expansion or contraction allowing for adjustment of tip and tilt of the mirror.

In one example, the adjusting is conducted during manufacture of the optical communications terminal. In another example, the adjusting is conducted manually. In a further example, adjusting the one or more fasteners includes adjusting a plurality of fasteners.

### BRIEF DESCRIPTION OF THE DRAWINGS

FIG. 1 is a block diagram 100 of a first optical communications terminal and a second optical communications terminal in accordance with aspects of the disclosure.

FIG. 2 is a pictorial diagram 200 of an example system architecture for the first communications terminal of FIG. 1 in accordance with aspects of the disclosure.

FIG. 3 represents features of an OPA architecture represented as an example OPA chip in accordance with aspects of the disclosure.

FIG. 4 is a pictorial diagram of a network in accordance with aspects of the disclosure.

FIG. 5 illustrates an example flexure in accordance with aspects of the disclosure.

FIG. 6 illustrates an example flexure in accordance with aspects of the disclosure.

FIG. 7 illustrates an example flexure in accordance with aspects of the disclosure.

FIG. 8 illustrates an example flexure in accordance with aspects of the disclosure.

FIG. 9 illustrates an example flexure in accordance with aspects of the disclosure.

FIGS. 10A-B illustrate an example system in accordance with aspects of the disclosure.

FIG. 11 is a flow diagram in accordance with aspects of the disclosure.

### DETAILED DESCRIPTION

### OVERVIEW

Aspects of the technology relates to alignment of components of an optical communications terminal. Specifically, alignment of a mirror (e.g., steering mirror) with other components of the optical communications terminal using a flexure connected thereto. The flexure may be configured to expand and contract allowing for adjustment of tip and tilt of the mirror. The mirror in conjunction with other components of the optical communications terminal may be configured to transmit and receive signals or beams (e.g., optical communications signals or beams) with remote terminals. In some examples, the alignment may be performed during manufacture. Additionally or alternatively, the alignment may be a one-time adjustment.

In this regard, systems and methods described herein may allow for alignment of a mirror with other components of an optical communications terminal without need to power up and actuate the mirror. Additionally, the alignment using the flexure may allow for substantially larger changes in tip and tilt than with actuators of the mirror alone. Moreover, flexure may allow for low cost and easily manufacturable components to assist in mirror alignment.

### EXAMPLE SYSTEMS

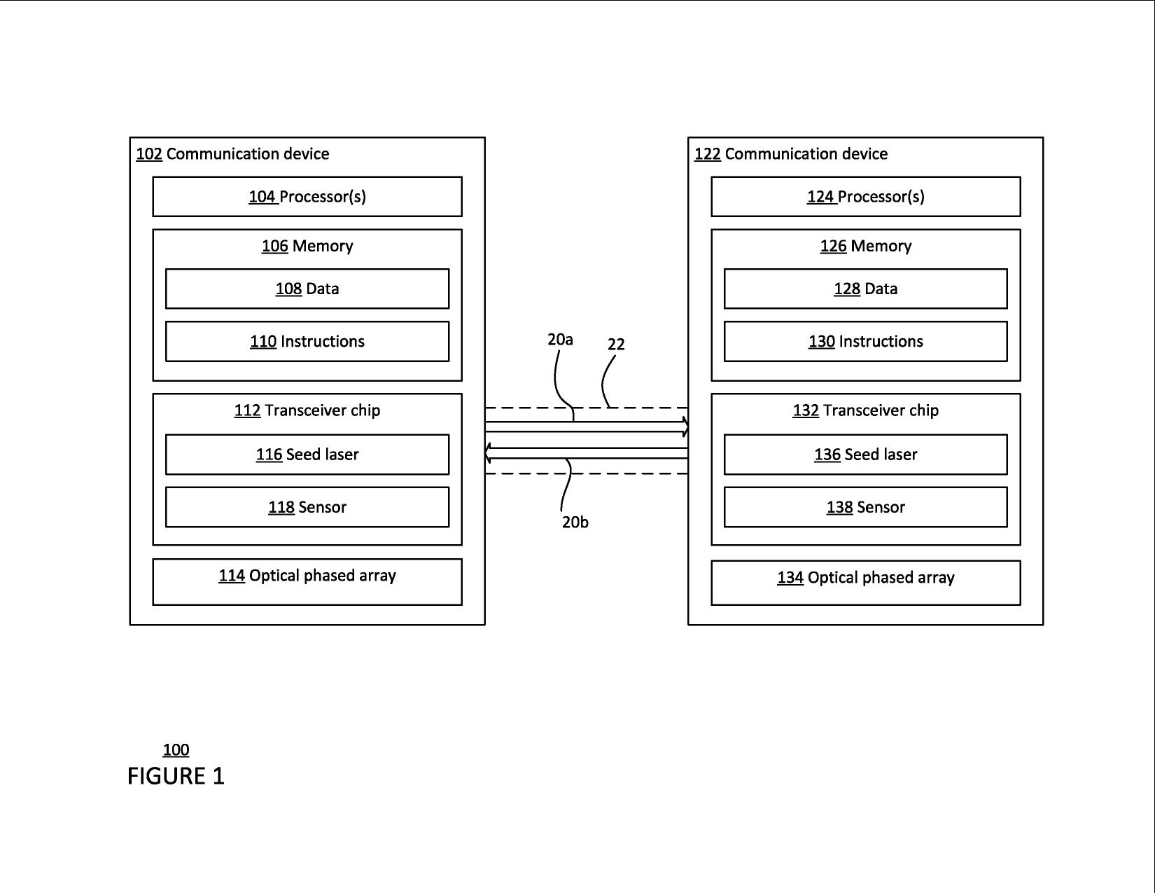

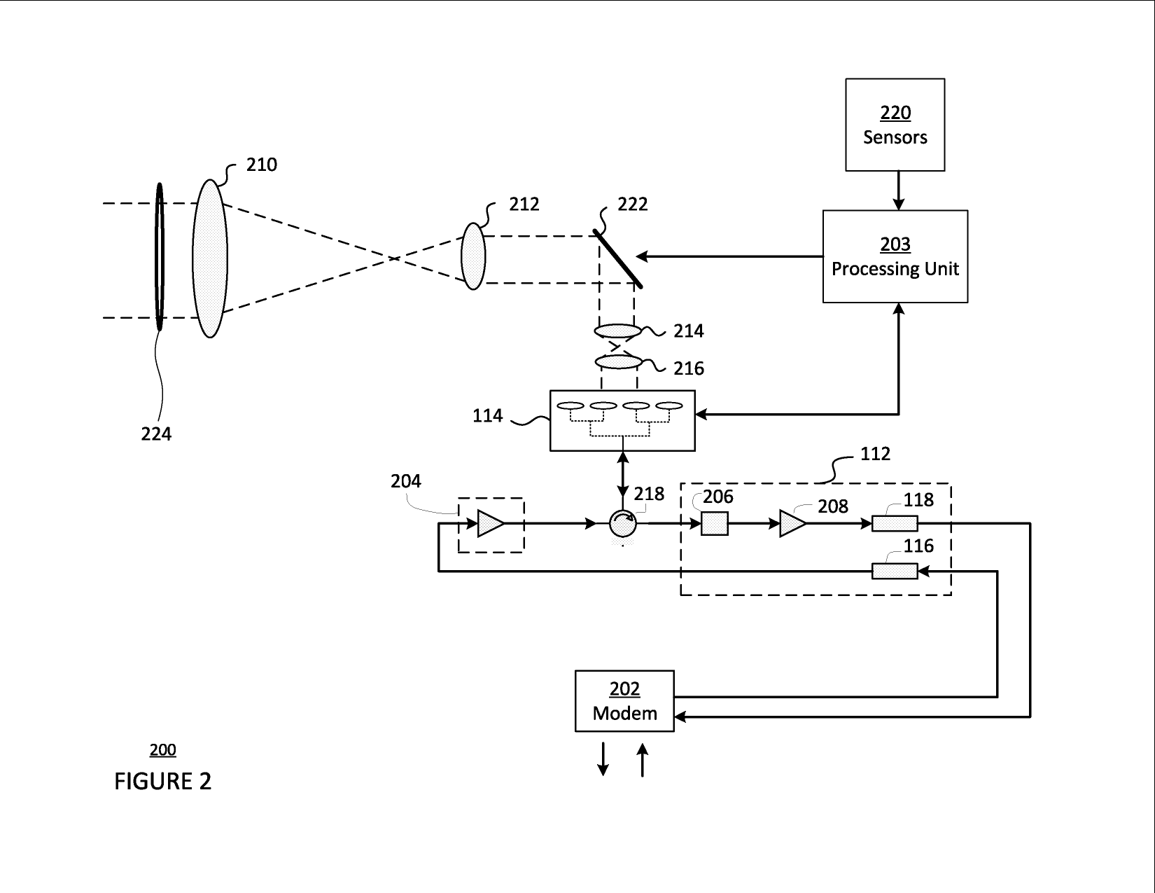

FIG. 1 is a block diagram 100 of a first optical communications terminal configured to form one or more links with a second optical communications terminal, for instance as part of a system such as a free-space optical communication (FSOC) system. FIG. 2 is a pictorial diagram 200 of an example communications terminal, such as the first optical communications terminal of FIG. 1. For example, a first optical communications terminal 102 includes one or more processors 104, a memory 106, a transceiver photonic integrated chip 112, and an optical phased array (OPA) architecture 114. In some implementations, the first optical communications terminal 102 may include more than one transceiver chip and/or more than one OPA architecture (e.g., more than one OPA chip).

The one or more processors 104 may be any conventional processors, such as commercially available CPUs. Alternatively, the one or more processors may be a dedicated device such as an application specific integrated circuit (ASIC) or another hardware-based processor, such as a field programmable gate array (FPGA). Although FIG. 1 functionally illustrates the one or more processors 104 and memory 106 as being within the same block, such as in a modem 202 for digital signal processing shown in FIG. 2, the one or more processors 104 and memory 106 may actually comprise multiple processors and memories that may or may not be stored within the same physical housing, such as in both the modem 202 and a separate processing unit 203. Accordingly, references to a processor or computer will be understood to include references to a collection of processors or computers or memories that may or may not operate in parallel.

Memory 106 may store information accessible by the one or more processors 104, including data 108, and instructions 110, that may be executed by the one or more processors 104. The memory may be of any type capable of storing information accessible by the processor, including a computer-readable medium such as a hard-drive, memory card, ROM, RAM, DVD or other optical disks, as well as other write-capable and read-only memories. The system and method may include different combinations of the foregoing, whereby different portions of the data 108 and instructions 110 are stored on different types of media. In the memory of each communications terminal, such as memory 106, calibration information, such as one or more offsets determined for tracking a signal, may be stored.

Data 108 may be retrieved, stored or modified by one or more processors 104 in accordance with the instructions 110. For instance, although the system and method are not limited by any particular data structure, the data 108 may be stored in computer registers, in a relational database as a table having a plurality of different fields and records, XML documents or flat files. The data 108 may also be formatted in any computer-readable format such as, but not limited to, binary values or Unicode. By further way of example only, image data may be stored as bitmaps including grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data 108 may comprise any information sufficient to identify the relevant information, such as numbers, descriptive text, proprietary codes, references to data stored in other areas of the same memory or different memories (including other network locations) or information that is used by a function to calculate the relevant data.

The instructions 110 may be any set of instructions to be executed directly (such as machine code) or indirectly (such as scripts) by the one or more processors 104. For example, the instructions 110 may be stored as computer code on the computer-readable medium. In that regard, the terms "instructions" and "programs" may be used interchangeably herein. The instructions 110 may be stored in object code format for direct processing by the one or more processors 104, or in any other computer language including scripts or collections of independent source code modules that are interpreted on demand or compiled in advance. Functions, methods and routines of the instructions 110 are explained in more detail below.

The one or more processors 104 may be in communication with the transceiver chip 112. As shown in FIG. 2, the one or more processors in the modem 202 may be in communication with the transceiver chip 112, being configured to receive and process incoming optical signals and to transmit optical signals. The transceiver chip 112 may include one or more transmitter components and one or more receiver components. The one or more processors 104 may therefore be configured to transmit, via the transmitter components, data in a signal, and also may be configured to receive, via the receiver components, communications and data in a signal. The received signal may be processed by the one or more processors 104 to extract the communications and data.

The transmitter components may include at minimum a light source, such as seed laser 116. Other transmitter components may include an amplifier, such as a high-power semiconductor optical amplifier 204. In some implementations, the amplifier is on a separate photonics chip. The seed laser 116 may be a distributed feedback laser (DFB), a laser diode, a fiber laser, or a solid-state laser. The light output of the seed laser 116, or optical signal, may be controlled by a current, or electrical signal, applied directly to the seed laser, such as from a modulator that modulates a received electrical signal. Light transmitted from the seed laser 116 is received by the OPA architecture 114.

The receiver components may include at minimum a sensor 118, such as a photodiode. The sensor may convert a received signal (e.g., light or optical communications beam), into an electrical signal that can be processed by the one or more processors. Other receiver components may include an attenuator, such as a variable optical attenuator 206, an amplifier, such as a semiconductor optical amplifier 208, or a filter.

The one or more processors 104 may be in communication with the OPA architecture 114. The OPA architecture 114 may include a micro-lens array, an emitter associated with each micro-lens in the array, a plurality of phase shifters, and waveguides that connect the components in the OPA. The OPA architecture may be positioned on a single chip, an OPA chip. The waveguides progressively merge between a plurality of emitters and an edge coupler that connect to other transmitter and/or receiver components. In this regard, the waveguides may direct light between photodetectors or fiber outside of the OPA architecture, the phase shifters, the waveguide combiners, the emitters and any additional component within the OPA. In particular, the waveguide configuration may combine two waveguides at each stage, which means the number of waveguides is reduced by a factor of two at every successive stage closer to the edge coupler. The point of combination may be a node, and a combiner may be at each node. The combiner may be a 2x2 multimode interference (MMI) or directional coupler.

The OPA architecture 114 may receive light from the transmitter components and outputs the light as a coherent communications beam to be received by a remote communications terminal or client device, such as second optical communications terminal 122. The OPA architecture 114 may also receive light from free space, such as a communications beam from second optical communications terminal 122, and provides such received light to the receiver components. The OPA architecture may provide the necessary photonic processing to combine an incoming optical communications beam into a single-mode waveguide that directs the beam towards the transceiver chip 112. In some implementations, the OPA architecture may also generate and provide an angle of arrival estimate to the one or more processors 104, such as those in processing unit 203.

The first optical communications terminal 102 may include additional components to support functions of the communications terminal. For example, the first optical communications terminal may include one or more lenses and/or mirrors that form a telescope. The telescope may receive collimated light and output collimated light. The telescope may include an objective portion, an eyepiece portion, and a relay portion. As shown in FIG. 2, the first optical communications terminal may include a telescope including an objective lens 210, an eyepiece lens 212, relay lenses 214, 216, and an aperture 224 (or opening) through which light may enter and exit the communications terminal. For ease of representation and understanding, the aperture 224 is depicted as distinct from the objective lens 210, though the objective lens 210 may be positioned within the aperture. The first optical communications terminal may include a circulator or wavelength splitter, such as a single mode circulator 218, that routes incoming light and outgoing light while keeping them on at least partially separate paths. The first optical communications terminal may include one or more sensors 220 for detecting measurements of environmental features and/or system components.

The first optical communications terminal 102 may include one or more steering mechanisms, such as one or more bias means for controlling one or more phase shifters, which may be part of the OPA architecture 114, and/or an actuated/steering mirror 222, such as a fast/fine pointing mirror. In some examples, the actuated mirror may be a MEMS 2-axis mirror, 2-axis voice coil mirror, or a piezoelectric 2-axis mirror. The one or more processors 104, such as those in the processing unit 203, may be configured to receive and process signals from the one or more sensors 220, the transceiver chip 112, and/or the OPA architecture 114 and to control the one or more steering mechanisms to adjust a pointing direction and/or wavefront shape. The first optical communications terminal also includes optical fibers or waveguides connecting optical components, creating a path between the seed laser 116 and OPA architecture 114 and a path between the OPA architecture 114 and the sensor 118.

Returning to FIG. 1, the second optical communications terminal 122 may output the Tx signals as an optical communications beam 20b (e.g., light) pointed towards the first optical communications terminal 102, which receives the optical communications beam 20b (e.g., light) as corresponding Rx signals. In this regard, the second optical communications terminal 122 includes one or more processors, 124, a memory 126, a transceiver chip 132, and an OPA architecture 134. The one or more processors 124 may be similar to the one or more processors 104 described above.

Memory 126 may store information accessible by the one or more processors 124, including data 128 and instructions 130 that may be executed by processor 124. Memory 126, data 128, and instructions 130 may be configured similarly to memory 106, data 108, and instructions 110 described above. In addition, the transceiver chip 132 and the OPA architecture 134 of the second optical communications terminal 122 may be similar to the transceiver chip 112 and the OPA architecture 114. The transceiver chip 132 may include both transmitter components and receiver components. The transmitter components may include a light source, such as seed laser 136 configured similar to the seed laser 116. Other transmitter components may include an amplifier, such as a high-power semiconductor optical amplifier. The receiver components may include a sensor 138 configured similar to sensor 118. Other receiver components may include an attenuator, such as a variable optical attenuator, an amplifier, such as a semiconductor optical amplifier, or a filter. The OPA architecture 134 may include an OPA chip including a micro-lens array, a plurality of emitters, a plurality of phase shifters. Additional components for supporting functions of the second optical communications terminal 122 may be included similar to the additional components described above. The second optical communications terminal 122 may have a system architecture that is same or similar to the system architecture shown in FIG. 2.

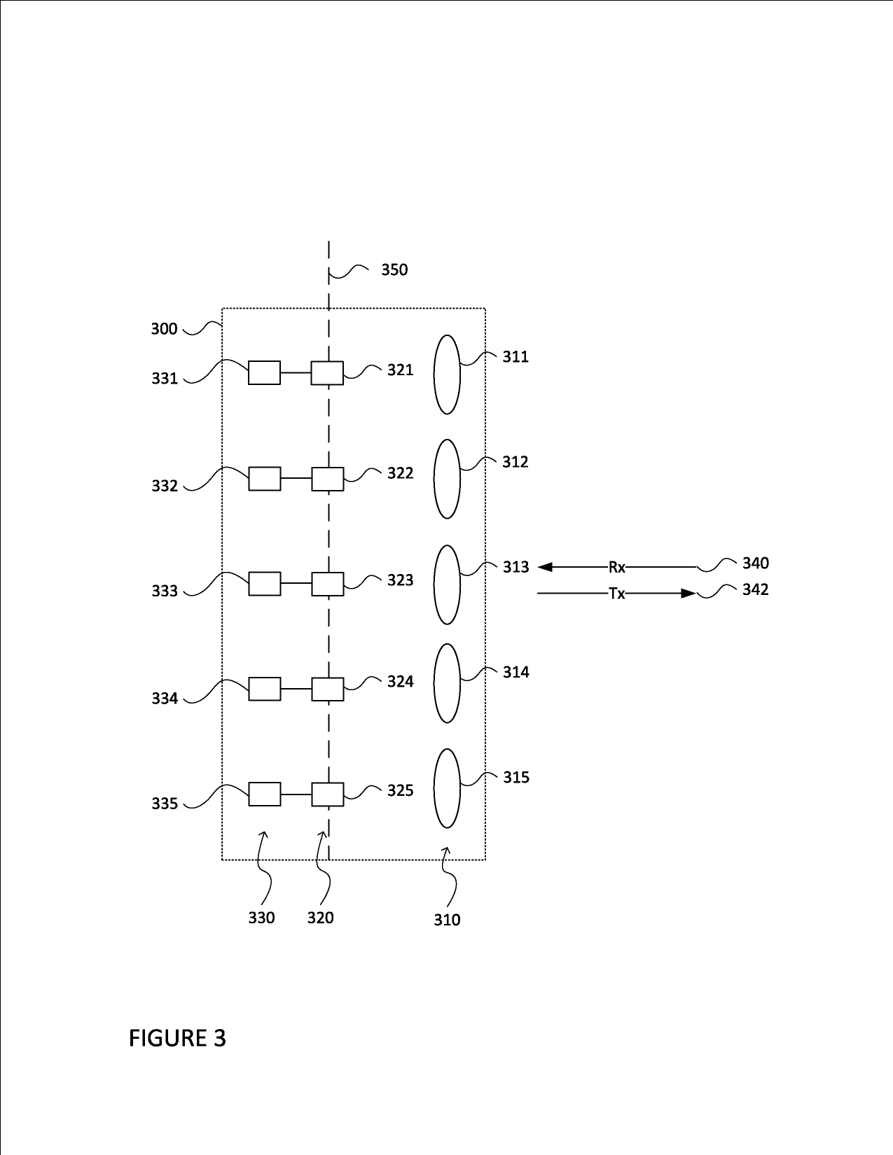

FIG. 3 represents features of OPA architecture 114 represented as an example OPA chip 300 including representations of a micro-lens array 310, a plurality of emitters 320, and a plurality of phase shifters 330. For clarity and ease of understanding, additional waveguides and other features are not depicted. Arrows 340, 342 represent the general direction of Tx signals (transmitted optical communications beam) and Rx signals (received optical communications beam) as such signals pass or travel through the OPA chip 300.

The micro-lens array 310 may include a plurality of convex micro-lenses 311-315 that focus the Rx signals onto respective ones of the plurality emitters positioned at the focal points of the micro-lens array. In this regard, the dashed-line 350 represents the focal plane of the micro-lenses 311-315 of the micro-lens array 310. The micro-lens array 310 may be arranged in a grid pattern with a consistent pitch, or distance, between adjacent lenses. In other examples, the micro-lens array 310 may be in different arrangements having different numbers of rows and columns, different shapes, and/or different pitch (consistent or inconsistent) for different lenses.

Each micro-lens of the micro-lens array may be 10’s to 1000's of micrometers in diameter and height. In addition, each micro-lens of the micro-lens array may be manufactured by molding, printing, or etching a lens directly into a wafer of the OPA chip 300. Alternatively, the micro-lens array 310 may be molded, printed, or etched as a separately fabricated micro-lens array. In this example, the micro-lens array 310 may be a rectangular or square plate of glass or silica a few mm (e.g., 10 mm or more or less) in length and width and 0.2 mm or more or less thick. Integrating the micro-lens array within the OPA chip 300 may allow for the reduction of the grating emitter size and an increase in the space between emitters. In this way, two-dimensional waveguide routing in the OPA architecture may better fit in a single layer optical phased array. In other instances, rather than a physical micro-lens array, the function of the micro-lens array may be replicated using an array of diffractive optical elements (DOE).

Each micro-lens of the micro-lens array may be associated with a respective emitter of the plurality of emitters 320. For example, each micro-lens may have an emitter from which Tx signals are received and to which the Rx signals are focused. As an example, micro-lens 311 is associated with emitter 321. Similarly, each micro-lens 312-315 also has a respective emitter 322-325. In this regard, for a given pitch (i.e., edge length of a micro-lens) the micro-lens focal length may be optimized for best transmit and receive coupling to the underlying emitters. This arrangement may thus increase the effective fill factor of the Rx signals at the respective emitter, while also expanding the Tx signals received at the micro-lenses from the respective emitter before the Tx signals leave the OPA chip 300.

The plurality of emitters 320 may be configured to convert emissions from waveguides to free space and vice versa. The emitters may also generate a specific phase and intensity profile to further increase the effective fill factor of the Rx signals and improve the wavefront of the Tx signals. The phase and intensity profile may be determined using inverse design or other techniques in a manner that accounts for how transmitted signals will change as they propagate to and through the micro-lens array. The phase profile may be different from the flat profile of traditional grating emitters, and the intensity profile may be different from the gaussian intensity profile of traditional grating emitters. However, in some implementations, the emitters may be Gaussian field profile grating emitters.

The phase shifters 330 may allow for sensing and measuring Rx signals and the altering of Tx signals to improve signal strength optimally combining an input wavefront into a single waveguide or fiber. Each emitter may be associated with a phase shifter. As shown in FIG. 3, each emitter may be connected to a respective phase shifter. As an example, the emitter 320 is associated with a phase shifter 330. The Rx signals received at the phase shifters 331-335 may be provided to receiver components including the sensor 118, and the Tx signals from the phase shifters 331-335 may be provided to the respective emitters of the plurality of emitters 320. The architecture for the plurality of phase shifters 330 may include at least one layer of phase shifters having at least one phase shifter connected to an emitter of the plurality of emitters 320. In some examples, the phase shifter architecture may include a plurality of layers of phase shifters, where phase shifters in a first layer may be connected in series with one or more phase shifters in a second layer.

A communication link 22 may be formed between the first optical communications terminal 102 and the second optical communications terminal 122 when the transceivers of the first and second optical communications terminals are aligned. The alignment can be determined using the optical communications beams 20a, 20b to determine when line-of-sight is established between the communications terminals 102, 122. Using the communication link 22, the one or more processors 104 can send communication signals using the optical communications beam 20a to the second optical communications terminal 122 through free space, and the one or more processors 124 can send communication signals using the optical communications beam 20b to the first optical communications terminal 102 through free space. The communication link 22 between the first and second optical communications terminals 102, 122 allows for the bi-directional transmission of data between the two devices. In particular, the communication link 22 in these examples may be free-space optical communications (FSOC) links. In other implementations, one or more of the communication links 22 may be radio-frequency communication links or other types of communication link capable of traveling through free space.

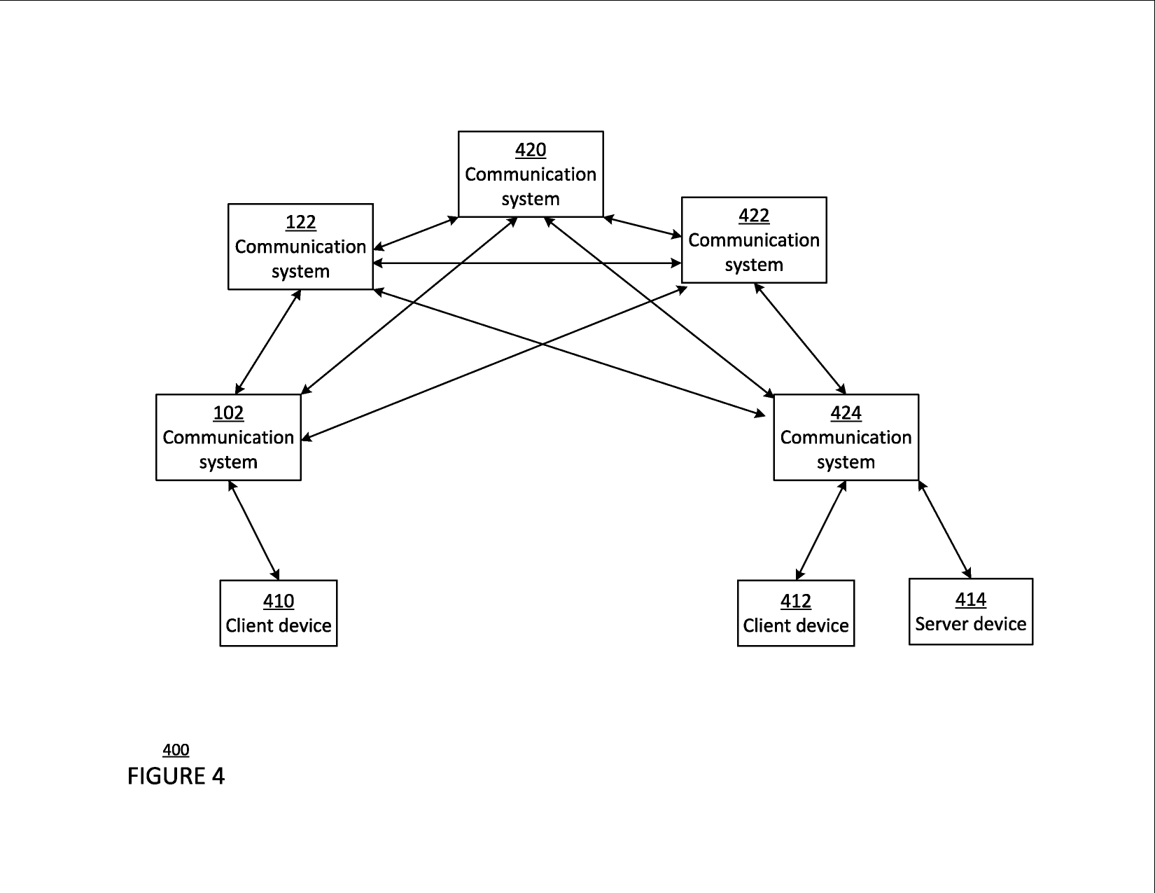

As shown in FIG. 4, a plurality of communications terminals, such as the first optical communications terminal 102 and the second optical communications terminal 122, may be configured to form a plurality of communication links (illustrated as arrows) between a plurality of communications terminals, thereby forming a network 400. The network 400 may include client devices 410 and 412, server device 414, and communications terminals 102, 122, 420, 422, and 424. Each of the client devices 410, 412, server device 414, and communications terminals 420, 422, and 424 may include one or more processors, a memory, a transceiver chip, and an OPA architecture (e.g., OPA chip or chips) similar to those described above. Using the transmitter and the receiver, each communications terminal in network 400 may form at least one communication link with another communications terminal, as shown by the arrows. The communication links may be for optical frequencies, radio frequencies, other frequencies, or a combination of different frequency bands. In FIG. 4, the first optical communications terminal 102 is shown having communication links with client device 410 and communications terminals 122, 420, and 422. The second optical communications terminal 122 is shown having communication links with communications terminals 102, 420, 422, and 424.

The network 400 as shown in FIG. 4 is illustrative only, and in some implementations the network 400 may include additional or different communications terminals. The network 400 may be a terrestrial network where the plurality of communications terminals is on a plurality of ground communications terminals. In other implementations, the network 400 may include one or more high-altitude platforms (HAPs), which may be balloons, blimps or other dirigibles, airplanes, unmanned aerial vehicles (UAVs), satellites, or any other form of high-altitude platform, or other types of movable or stationary communications terminals. In some implementations, the network 400 may serve as an access network for client devices such as cellular phones, laptop computers, desktop computers, wearable devices, or tablet computers. The network 400 also may be connected to a larger network, such as the Internet, and may be configured to provide a client device with access to resources stored on or provided through the larger computer network.

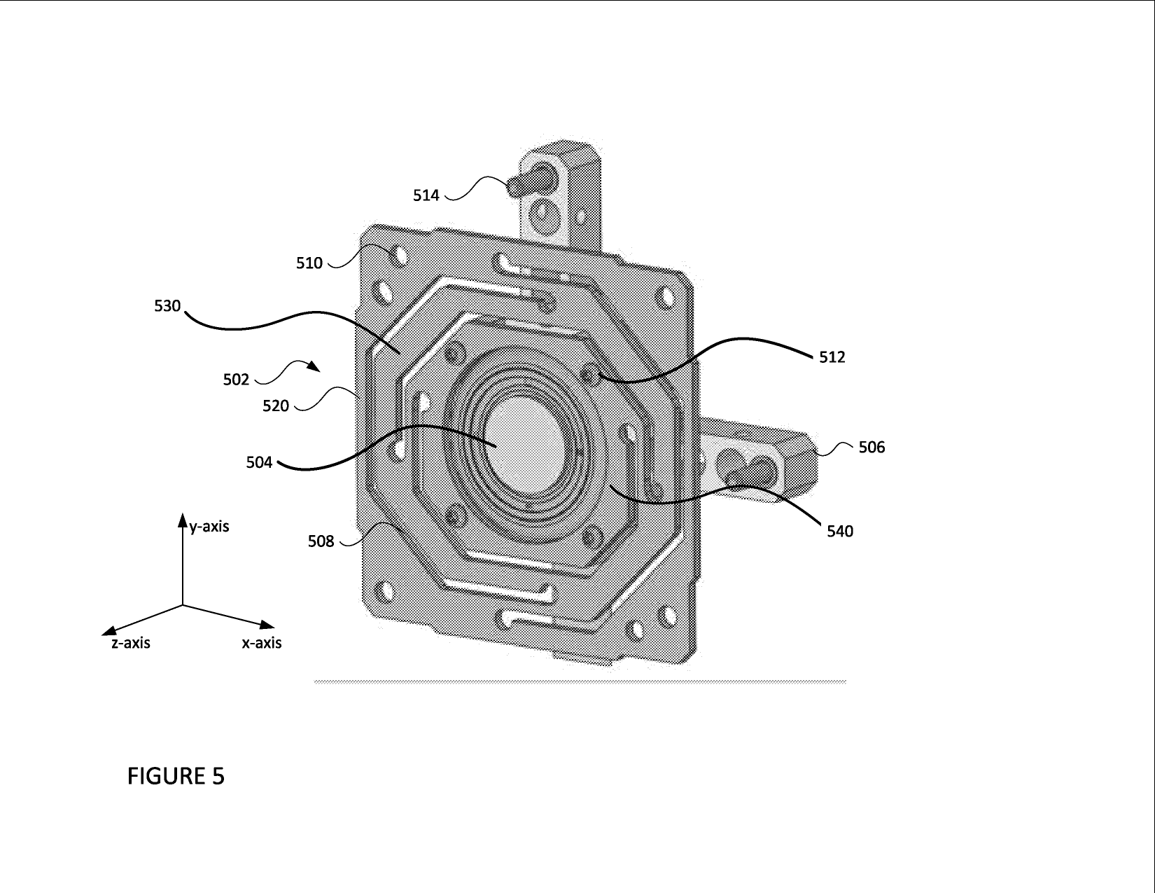

As discussed above, an optical communications terminal (e.g., first optical communications terminal 102, second optical communications terminal 122) may include a flexure for adjustment of a mirror of the optical communications terminal. FIG. 5 illustrates an example flexure 502 connected to mirror 504 and movable support structure 506. The mirror 504 may be an actuated/steering mirror, such as actuated/steering mirror 222.

Flexure 502 includes one or more discontinuities 508 and a plurality of fastener locations 510, 512. The one or more discontinuities 508 may allow for expansion and contraction of the flexure 502. In this regard, during expansion and contraction, one or more inner portions 530, 540 of the flexure 502 may move relative to an outer portion 520 of the flexure 502 thereby allowing for adjustment of a tip and/or a tilt of the mirror 504. The adjustment of the tip and tilt of the mirror may allow for the mirror to be aligned with other components of the optical communications terminal (e.g., objective lens 210, eyepiece lens 212, relay lenses 214, 216, aperture 224, OPA architecture 114) such that a maximum amount of power or intensity of optical beams or signals may be conveyed therethrough. In some instances, the maximum adjustment of a tip and/or a tilt may be less than or equal to 2 degrees or more or less.

The one or more inner portions 530, 540 may be delineated from the outer portion 520 by the one or more discontinuities 508. During expansion of the flexure, the one or more inner portions 530, 540 may move away from the outer portion 520 in the z direction. Similarly, during contraction of the flexure, the one or more inner portions 530, 540 may move towards the outer portion 520 in the z direction. The combination of this expansion and contraction may thus enable adjustment of the flexure and thereby movement to a desired tip and tilt of the mirror with respect to the other components of the optical terminal.

The plurality of fastener locations 510, 512 may allow the flexure 502 to be secured to other components of the optical communications terminal using various fasteners such as, for example, screws. For instance, fastener locations 510 in the outer portion 520 of the flexure 502 may allow the flexure 502 to be secured to a housing of the optical communications terminal. Additionally, fastener locations 512 in the one or more inner portions 530, 540 of the flexure 502 to be secured to the movable support structure 506.

The movable support structure 506 may include one or more arm structures that support positioning of the flexure with respect to the housing of the optical communications terminal. The movable support structure 506 also includes one or more fasteners 514 (e.g., screws, only a portion of which is depicted in FIG. 5). The one or more fasteners 514 may allow the movable support structure 506 to be secured to the housing of the optical communications terminal. The one or more fasteners 514 may be adjusted by tightening or loosening one or more fasteners 514. The adjustment may also allow for the aforementioned expansion and contraction of the flexure 502. In this regard, the one or more fasteners 514 may be loosened during expansion allowing for movement of the one or more inner portions 530, 540 of the flexure 502 in the z direction away from the outer portion 520. Additionally, the one or more fasteners 514 may be tightened during contraction allowing for movement of the one or more inner portions 530, 540 of the flexure 502 in the z direction towards the outer portion 520.

In some instances, the adjustment of the one or more fasteners 514 may be conducted during construction or manufacture of the optical communications terminal. Additionally or alternatively, in some instances, the adjustment of the one or more fasteners 514 may be conducted manually. The adjustment may be conducted based on one or more measures of power and/or intensity of optical beams or signals passing through components of the terminal. The adjustment may be continued until a maximum power and/or intensity of the optical beams is measured. In some instances, the measures of the power and/or intensity of optical beams or signals may be taken by receiver components of the optical communications device (e.g., sensor 138). In some instances, the one or more fasteners 514 may be a plurality of fasteners. In such an instance, one of the plurality of fasteners may be adjusted to achieve a desired tip and tilt of the mirror with respect to the other components of the optical communications terminal. Alternatively, more than one or all of the plurality of fasteners may be adjusted to achieve a desired tip and tilt of the mirror with respect to the other components of the optical communications terminal.

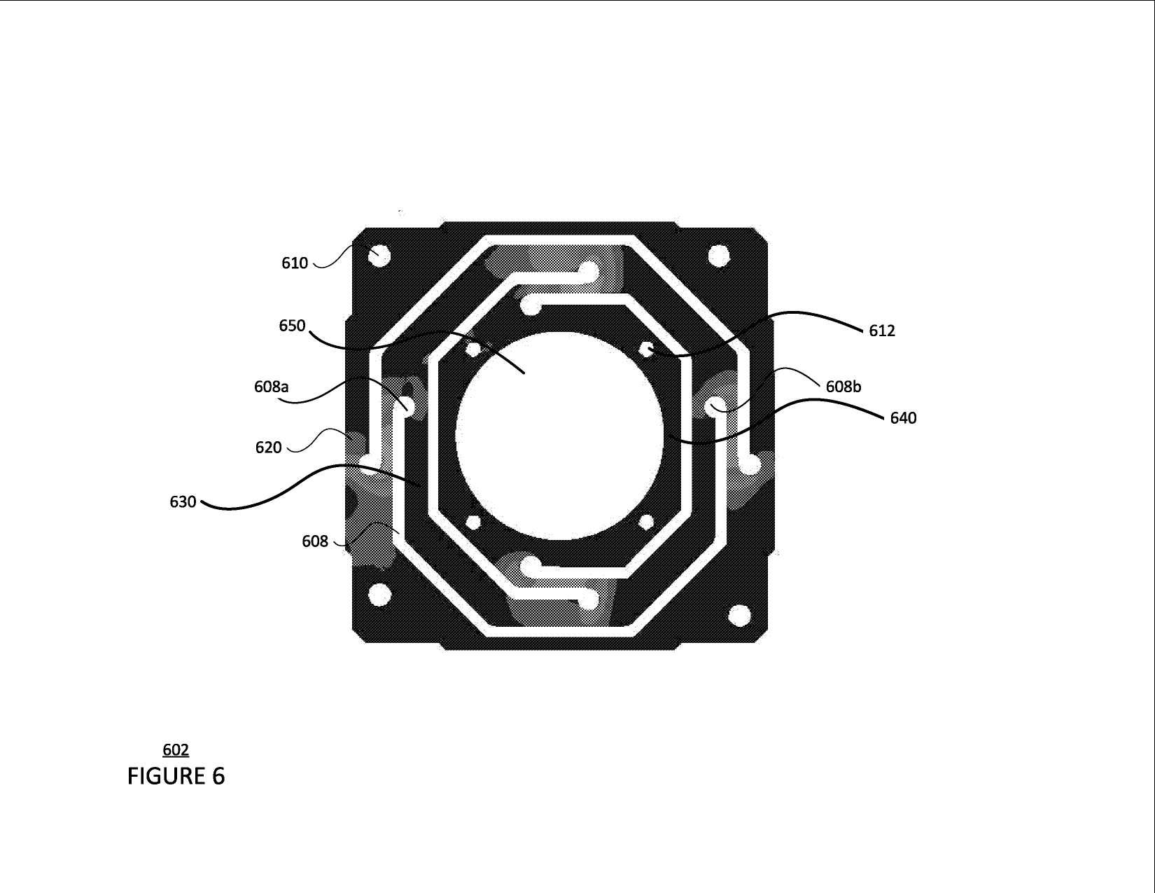

A flexure for adjustment of a mirror of an optical communications terminal, such as flexure 502, may be configured in numerous ways to allow for expansion and contraction. In some instances, the flexure may be constructed of a metal (e.g., stainless steel). Additionally or alternatively the flexure may be conducted by photochemically etching, use of a water jet, or laser cutting. Additionally or alternatively, the flexure may be substantially symmetrical. FIGS. 6-9 illustrate various example configurations of the flexure comparable to flexure 502 of FIG. 5. While FIGS. 6-9 do not depict a mirror, a mirror, such as mirror 222, 504, may be disposed in an inner discontinuity of the flexure as illustrated in FIG. 5 and discussed below. As with flexure 502, each of the following flexures are capable of the combination of this expansion and contraction and may thus enable movement to a desired tip and tilt of a mirror with respect to the other components of the optical terminal.

FIG. 6 illustrates an example flexure 602. The example flexure 602 includes a plurality of discontinuities 608, an outer portion 620, a first inner portion 630, a second inner portion 640, and an inner discontinuity 650. Flexure 502 may be comparable to flexure 602. For example, the plurality of discontinuities 608 and the one or more discontinuities 508 may be configured in the same or similar manner; the outer portion 620 may be configured in the same or similar manner as the outer portion 520 of flexure 502 discussed above; the first inner portion 630 and the second inner portion 640 may be configured in the same or the one or more inner portions 530, 540 of flexure 502 discussed above. Additionally, flexure 602 may be compatible with a movable support structure, such as movable support structure 506.

The plurality of discontinuities 608 form a substantially spiral shape. Each discontinuity of the plurality of discontinuities 608 includes a first end 608a and a second end 608b. The first and second ends 608a, 608b may be approximately circular. The first and second ends 608a, 608b of each discontinuity may be located at or adjacent to a connection point between portions of the flexure. In this regard, the first and second ends 608a, 608b may be located at or adjacent to points that connect different portions (e.g., the outer portion 620, first inner portion 630, second inner portion 640) of the flexure 602.

The outer portion 620 of the flexure 602 includes a plurality of fastener locations 610, similar to fastener location 510. The plurality of fastener locations 610 may allow the flexure 602 to be secured to other components of the optical communications terminal using various fasteners such as, for example, screws. The plurality of fastener locations 610 in the outer portion of the flexure 602 may allow the flexure 602 to be secured to a housing of the optical communications terminal. As illustrated in FIG. 6, the plurality of fastener locations 610 may be located in the corners of the outer portion 620 of flexure 602.

The first inner portion 630 of the flexure 602 is delineated from the outer portion 620 of the flexure by one or more of the plurality of discontinuities 608. The first inner portion 630 may be configured to move relative to the outer portion 620 during expansion and contraction of the flexure allowing for adjustment of a tip and/or a tilt of a mirror, such as mirror 222, 504, disposed in inner discontinuity 650. Similar to flexure 502 discussed above, the adjustment of the tip and tilt of the mirror may allow for the mirror to be aligned with other components of the optical communications terminal (e.g., objective lens 210, eyepiece lens 212, relay lenses 214, 216, aperture 224, OPA architecture 114) such that a maximum amount of power or intensity of optical beams or signals may be conveyed therethrough. In some instances, the maximum adjustment of a tip and/or a tilt may be less than or equal to 2 degrees or more or less. During expansion of the flexure 602, the first inner portion 630 may move away from the outer portion 620 in the z direction. Similarly, during contraction of the flexure 602, the first inner portion 630 may move towards the outer portion 620 in the z direction.

The second inner portion 640 of the flexure 602 is delineated from the first inner portion 630 by one or more of the plurality of discontinuities 608. The second inner portion 640 may be configured to move relative to first inner portion 630 and the outer portion 620 during expansion and contraction of the flexure allowing for adjustment of a tip and/or a tilt of a mirror, such as mirror 222, 504, disposed in inner discontinuity 650. During expansion of the flexure 602, the second inner portion 640 may move away from the first inner portion 630 and/or the outer portion 620 in the z direction. Similarly, during contraction of the flexure 602, the second inner portion may move towards the first inner portion 630 and/or the outer portion 620 in the z direction. The combination of this expansion and contraction may thus enable adjustment of the flexure and thereby movement to a desired tip and tilt of the mirror with respect to the other components of the optical terminal.

The second inner portion includes a plurality of fastener locations 612, similar to fastener locations 512. The plurality of fastener locations 612 may allow the flexure 602 to be secured to other components of the optical communications terminal using various fasteners such as, for example, screws. The plurality of fastener locations 612 in the second inner portion of the flexure 602 may allow the flexure 602 to be secured to a movable support structure (e.g., movable support structure 506) of the optical communications terminal. As illustrated in FIG. 6, the plurality of fastener locations 612 may be located in the corners of the second inner portion 640 of flexure 602.

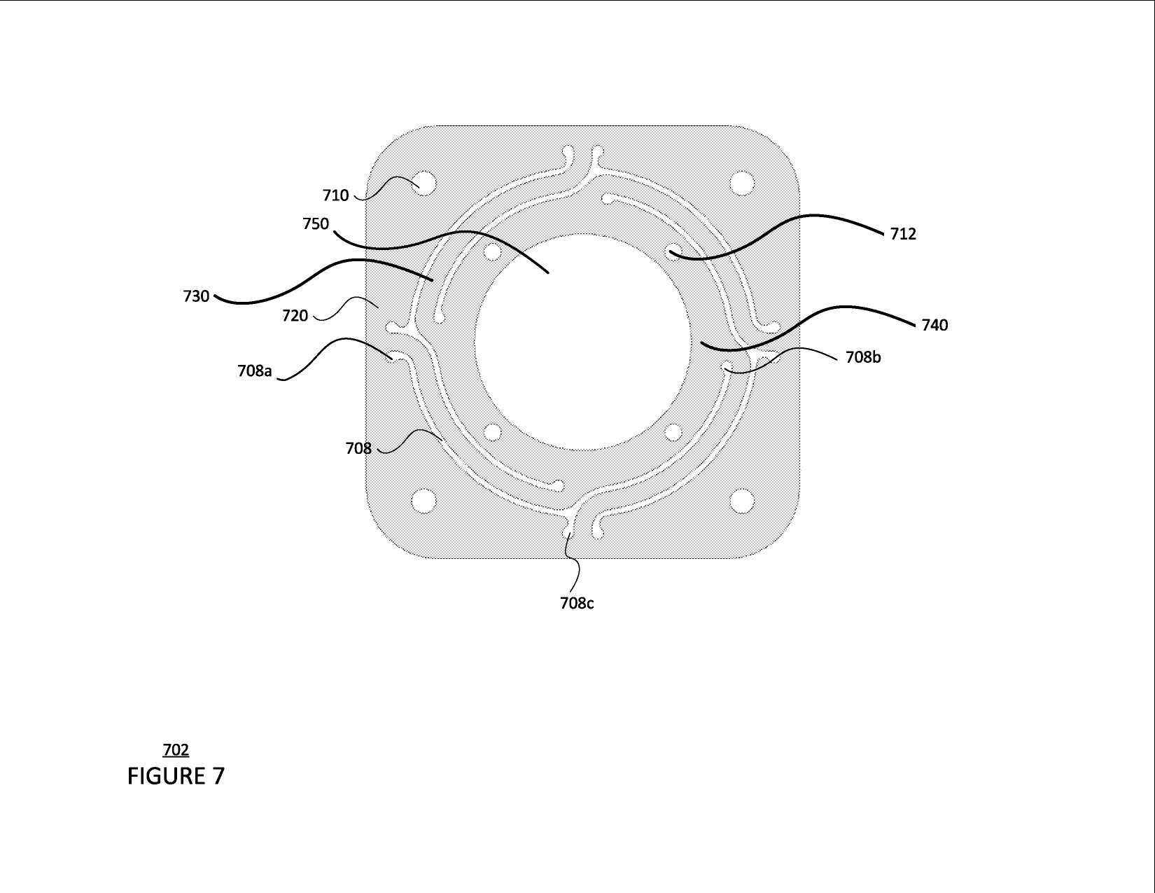

FIG. 7 illustrates an example flexure 702. The example flexure 702 includes a plurality of discontinuities 708, an outer portion 720, a first inner portion 730, a second inner portion 740, and an inner discontinuity 750. Flexure 502 may be comparable to flexure 702. For example, the plurality of discontinuities 708 and the one or more discontinuities 508 may be configured in the same or similar manner; the outer portion 720 may be configured in the same or similar manner as the outer portion 520 of flexure 502 discussed above; the first inner portion 730 and the second inner portion 740 may be configured in the same or the one or more inner portions 530, 540 of flexure 502 discussed above. Additionally, flexure 702 may be compatible with a movable support structure, such as movable support structure 506.

The plurality of discontinuities 708 form a substantially circular shape. Each discontinuity of the plurality of discontinuities 708 includes a first end 708a, a second end 708b, and a middle portion 708c. The first end 708a, the second end 708b, and the middle portion 708c may be approximately circular. The first end 708a, the second end 708b, and the middle portion 708c of each discontinuity may be located at or adjacent to a connection point between portions of the flexure. In this regard, first end 708a, the second end 708b, and the middle portion 708c may be located at or adjacent to points that connect different portions (e.g., the outer portion 720, first inner portion 730, second inner portion 740) of the flexure 702.

The outer portion 720 of the flexure 702 includes a plurality of fastener locations 710, similar to fastener location 510. The plurality of fastener locations 710 may allow the flexure 702 to be secured to other components of the optical communications terminal using various fasteners such as, for example, screws. The plurality of fastener locations 710 in the outer portion of the flexure 702 may allow the flexure 702 to be secured to a housing of the optical communications terminal. As illustrated in FIG. 7, the plurality of fastener locations 710 may be located in the corners of the outer portion 720 of flexure 702.

The first inner portion 730 of the flexure 702 is delineated from the outer portion 720 of the flexure by one or more of the plurality of discontinuities 708. The first inner portion 730 may be configured to move relative to the outer portion 720 during expansion and contraction of the flexure allowing for adjustment of a tip and/or a tilt of a mirror, such as mirror 222, 504, disposed in inner discontinuity 750. Similar to flexure 502 discussed above, the adjustment of the tip and tilt of the mirror may allow for the mirror to be aligned with other components of the optical communications terminal (e.g., objective lens 210, eyepiece lens 212, relay lenses 214, 216, aperture 224, OPA architecture 114) such that a maximum amount of power or intensity of optical beams or signals may be conveyed therethrough. In some instances, the maximum adjustment of a tip and/or a tilt may be less than or equal to 2 degrees or more or less. During expansion of the flexure 702, the first inner portion 730 may move away from the outer portion 720 in the z direction. Similarly, during contraction of the flexure 702, the first inner portion 730 may move towards the outer portion 720 in the z direction.

The second inner portion 740 of the flexure 702 is delineated from the first inner portion 730 by one or more of the plurality of discontinuities 708. The second inner portion 740 may be configured to move relative to first inner portion 730 and the outer portion 720 during expansion and contraction of the flexure allowing for adjustment of a tip and/or a tilt of a mirror, such as mirror 222, 504, disposed in inner discontinuity 750. During expansion of flexure 702, the second inner portion 740 may move away from the first inner portion 730 and/or the outer portion 720 in the z direction. Similarly, during contraction of the flexure 702, the second inner portion may move towards the first inner portion 730 and/or the outer portion 720 in the z direction. The combination of this expansion and contraction may thus enable adjustment of the flexure and thereby movement to a desired tip and tilt of the mirror with respect to the other components of the optical terminal

The second inner portion includes a plurality of fastener locations 712, similar to fastener locations 512. The plurality of fastener locations 712 may allow the flexure 702 to be secured to other components of the optical communications terminal using various fasteners such as, for example, screws. The plurality of fastener locations 712 in the second inner portion of the flexure 702 may allow the flexure 702 to be secured to a movable support structure (e.g., movable support structure 506) of the optical communications terminal. As illustrated in FIG. 7, the plurality of fastener locations 712 may be located approximately equidistant from one another.

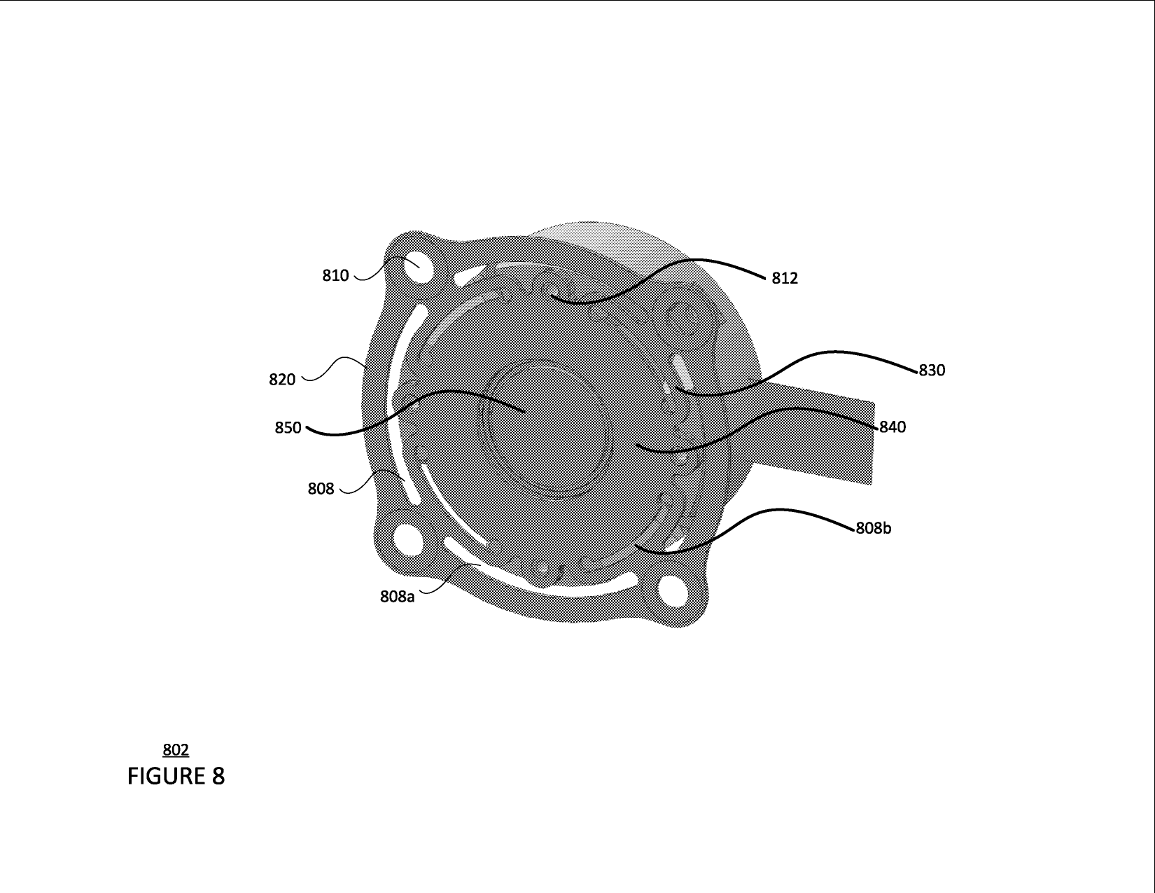

FIG. 8 illustrates an example flexure 802. The example flexure 802 includes a plurality of discontinuities 808, an outer portion 820, a first inner portion 830, a second inner portion 840, and an inner discontinuity 850. Flexure 502 may be comparable to flexure 802. For example, the plurality of discontinuities 808 and the one or more discontinuities 508 may be configured in the same or similar manner; the outer portion 820 may be configured in the same or similar manner as the outer portion 520 of flexure 502 discussed above; the first inner portion 830 and the second inner portion 840 may be configured in the same or the one or more inner portions 530, 540 of flexure 502 discussed above. Additionally, flexure 802 may be compatible with a movable support structure, such as movable support structure 506.

The plurality of discontinuities 808 form a substantially circular shape. The plurality of discontinuities 808 include a first set of discontinuities 808a at a first radius and a second set of discontinuities 808b at a second radius different from the first (e.g., less than). Each discontinuity of the plurality of discontinuities 808 may include a first end and a second end. The first and second ends of each discontinuity may be located at or adjacent to a connection point between portions of the flexure. The ends of the first set of discontinuities 808amay be located at or adjacent to a connection point between the outer portion 820 and the first inner portion 830. The ends of the second set of discontinuities 808b may be located at or adjacent to a connection point between the first inner portion 830 and the second inner portion 840.

The outer portion 820 of the flexure 802 includes a plurality of fastener locations 810, similar to fastener location 510. The plurality of fastener locations 810 may allow the flexure 802 to be secured to other components of the optical communications terminal using various fasteners such as, for example, screws. The plurality of fastener locations 810 in the outer portion of the flexure 802 may allow the flexure 802 to be secured to a housing of the optical communications terminal. As illustrated in FIG. 8, the plurality of fastener locations 810 may be located in the corners of the outer portion 820 of flexure 802.

The first inner portion 830 of the flexure 802 is delineated from the outer portion 820 of the flexure by one or more of the plurality of discontinuities 808. The first inner portion 830 may be configured to move relative to the outer portion 820 during expansion and contraction of the flexure allowing for adjustment of a tip and/or a tilt of a mirror, such as mirror 222, 504, disposed in inner discontinuity 850. Similar to flexure 502 discussed above, the adjustment of the tip and tilt of the mirror may allow for the mirror to be aligned with other components of the optical communications terminal (e.g., objective lens 210, eyepiece lens 212, relay lenses 214, 216, aperture 224, OPA architecture 114) such that a maximum amount of power or intensity of optical beams or signals may be conveyed therethrough. In some instances, the maximum adjustment of a tip and/or a tilt may be less than or equal to 2 degrees or more or less. During expansion of the flexure 802, the first inner portion 830 may move away from the outer portion 820 in the z direction. Similarly, during contraction of the flexure 802, the first inner portion 830 may move towards the outer portion 820 in the z direction.

The first inner portion includes a plurality of fastener locations 812, similar to fastener locations 512. The plurality of fastener locations 812 may allow the flexure 802 to be secured to other components of the optical communications terminal using various fasteners such as, for example, screws. The plurality of fastener locations 812 in the first inner portion of the flexure 802 may allow the flexure 802 to be secured to a movable support structure (e.g., movable support structure 506) of the optical communications terminal. As illustrated in FIG. 8, the plurality of fastener locations 812 may be located approximately equidistant from one another.

The second inner portion 840 of the flexure 802 is delineated from the first inner portion 830 by one or more of the plurality of discontinuities 808. The second inner portion 840 may be configured to move relative to first inner portion 830 and the outer portion 820 during expansion and contraction of the flexure allowing for adjustment of a tip and/or a tilt of a mirror, such as mirror 222, 504, disposed in inner discontinuity 850. During expansion of flexure 802, the second inner portion 840 may move away from the first inner portion 830 and/or the outer portion 820 in the z direction. Similarly, during contraction of the flexure 802, the second inner portion may move towards the first inner portion 830 and/or the outer portion 820 in the z direction. The combination of this expansion and contraction may thus enable adjustment of the flexure and thereby movement to a desired tip and tilt of the mirror with respect to the other components of the optical terminal.

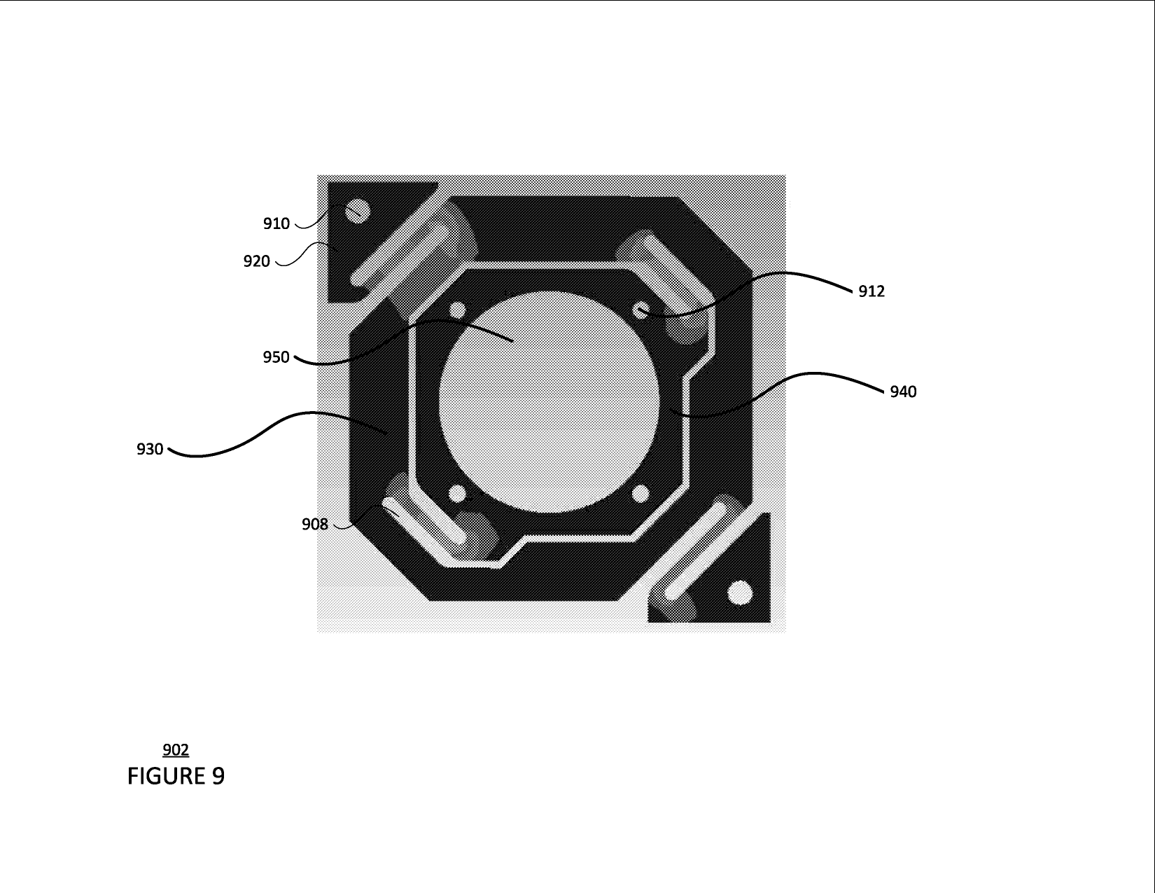

FIG. 9 illustrates an example flexure 902. The example flexure 902 includes a plurality of discontinuities 908, an outer portion 920, a first inner portion 930, a second inner portion 940, and an inner discontinuity 950. Flexure 502 may be comparable to flexure 902. For example, the plurality of discontinuities 908 and the one or more discontinuities 508 may be configured in the same or similar manner; the outer portion 920 may be configured in the same or similar manner as the outer portion 520 of flexure 502 discussed above; the first inner portion 930 and the second inner portion 940 may be configured in the same or the one or more inner portions 530, 540 of flexure 502 discussed above. Additionally, flexure 902 may be compatible with a movable support structure, such as movable support structure 506.

The plurality of discontinuities 908 form a substantially rectangular shape. Each discontinuity of the plurality of discontinuities 908 may include a first end. One or more discontinuities of the plurality of discontinuities 908 may include a second end. The first and second ends may be located at or adjacent to a connection point between portions of the flexure. In this regard, the first and second ends may be located at or adjacent to points that connect different portions (e.g., the outer portion 920, first inner portion 930, second inner portion 940) of the flexure 902.

The outer portion 920 as illustrated does not extend about the perimeter of the flexure 902. Instead, the outer portion 920 is located at two of the four corners of the flexure 902. The outer portion 920 of the flexure 902 includes a plurality of fastener locations 910, similar to fastener locations 510. The plurality of fastener locations 910 may allow the flexure 902 to be secured to other components of the optical communications terminal using various fasteners such as, for example, screws. The plurality of fastener locations 910 in the outer portion of the flexure 902 may allow the flexure 902 to be secured to a housing of the optical communications terminal. As illustrated in FIG. 9, the plurality of fastener locations 910 may be located in the two corners of the outer portion 920 of flexure 902.

The first inner portion 930 of the flexure 902 is delineated from the outer portion 920 of the flexure by one or more of the plurality of discontinuities 908. The first inner portion 930 may be configured to move relative to the outer portion 920 during expansion and contraction of the flexure allowing for adjustment of a tip and/or a tilt of a mirror, such as mirror 222, 504, disposed in inner discontinuity 950. Similar to flexure 502 discussed above, the adjustment of the tip and tilt of the mirror may allow for the mirror to be aligned with other components of the optical communications terminal (e.g., objective lens 210, eyepiece lens 212, relay lenses 214, 216, aperture 224, OPA architecture 114) such that a maximum amount of power or intensity of optical beams or signals may be conveyed therethrough. In some instances, the maximum adjustment of a tip and/or a tilt may be less than or equal to 2 degrees or more or less. During expansion of the flexure 902, the first inner portion 930 may move away from the outer portion 920 in the z direction. Similarly, during contraction of the flexure 902, the first inner portion 930 may move towards the outer portion 920 in the z direction.

The second inner portion 940 of the flexure 902 is delineated from the first inner portion 930 by one or more of the plurality of discontinuities 908. The second inner portion 940 may be configured to move relative to first inner portion 930 and the outer portion 920 during expansion and contraction of the flexure allowing for adjustment of a tip and/or a tilt of a mirror, such as mirror 222, 504, disposed in inner discontinuity 950. During expansion of the flexure 902, the second inner portion 940 may move away from the first inner portion 930 and/or the outer portion 920 in the z direction. Similarly, during contraction of the flexure 902, the second inner portion may move towards the first inner portion 930 and/or the outer portion 920 in the z direction. The combination of this expansion and contraction may thus enable adjustment of the flexure and thereby movement to a desired tip and tilt of the mirror with respect to the other components of the optical terminal.

The second inner portion includes a plurality of fastener locations 912, similar to fastener locations 512. The plurality of fastener locations 912 may allow the flexure 902 to be secured to other components of the optical communications terminal using various fasteners such as, for example, screws. The plurality of fastener locations 912 in the second inner portion of the flexure 902 may allow the flexure 902 to be secured to a movable support structure (e.g., movable support structure 506) of the optical communications terminal. As illustrated in FIG. 9, the plurality of fastener locations 912 may be located in the corners of the second inner portion 940 of flexure 902.

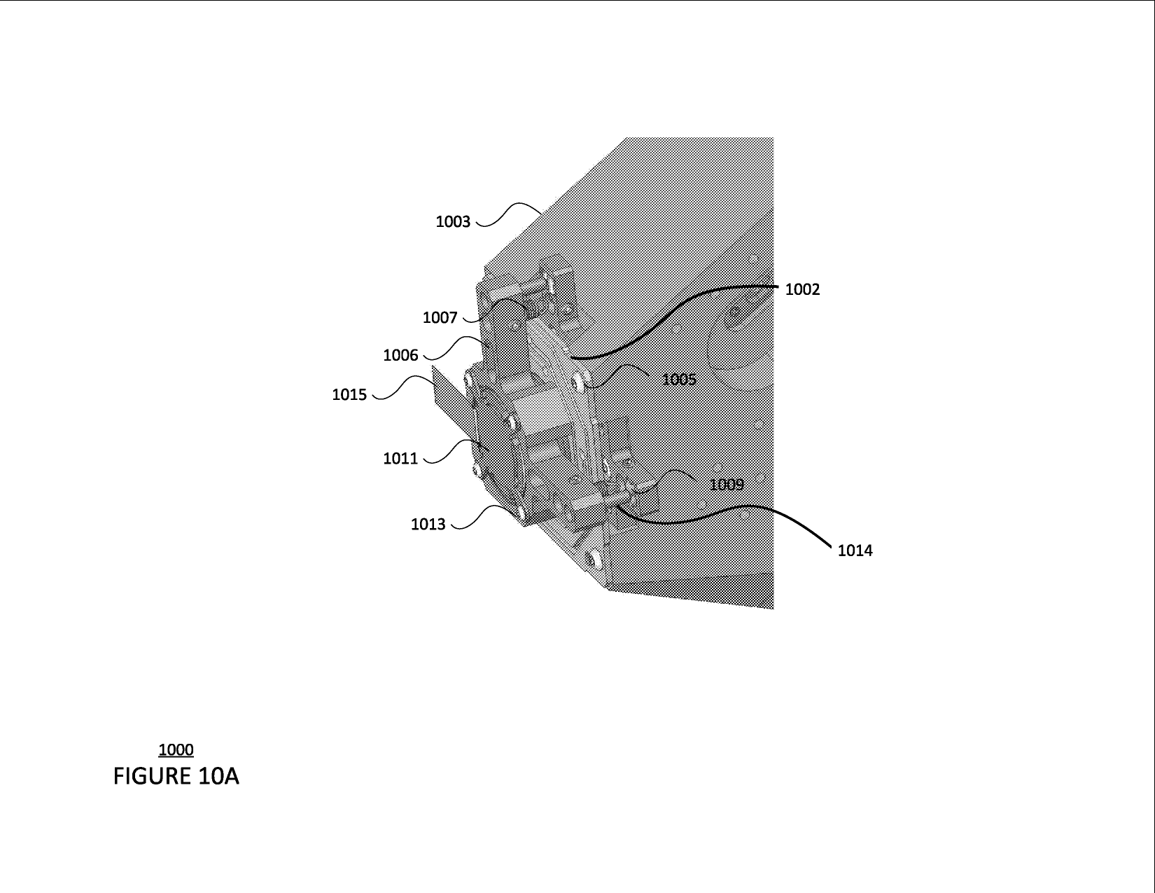

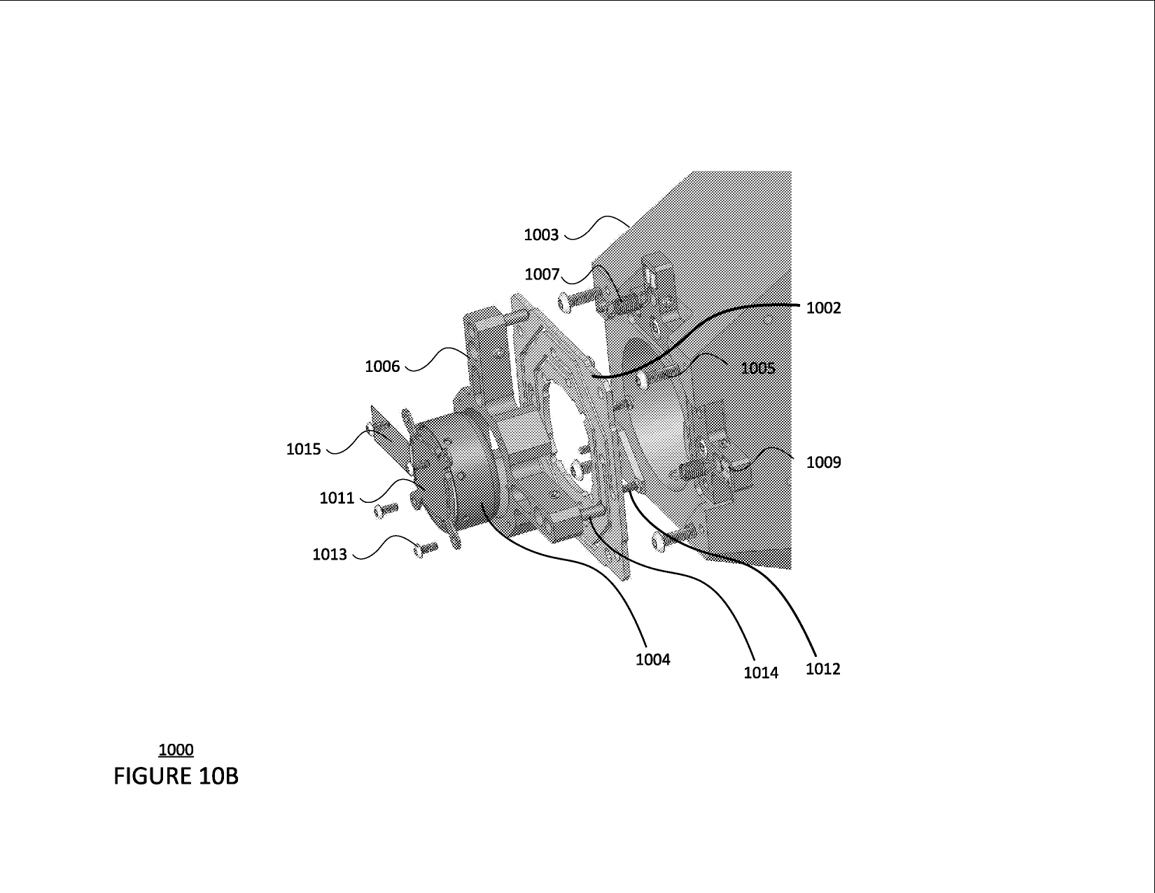

As discussed above, the flexure may be attached to one or more components of an optical communications terminal. FIGS. 10A-10B illustrate an example system 1000 including a flexure 1002 attached to other components of an optical communications terminal. The components of the system of FIGS. 10A-10B may be configured in the same or similar manner as components discussed with respect to FIGS. 5-9. For instance, flexure 1002, may be configured in the same or similar manner as flexures 502-902 as discussed above with respect to FIGS. 5-9. Flexure 1002 is attached to housing 1003 of an optical communications terminal by a plurality of fasteners 1005 (e.g., screws). The plurality of fasteners 1005 are located in an outer portion of the flexure 1002. Flexure 1002 is additionally attached to movable support structure 1006, comparable to movable support structure 506, by a plurality of fasteners 1012 (e.g., screws). The plurality of fasteners 1012 are located in an inner portion of one or more inner portions of flexure 1002. The movable support structure 1006 may include one or more arm structures that support positioning of the flexure with respect to the housing of the optical communications terminal.

Mirror 1004 is disposed in a discontinuity of the movable support structure 1006 and an inner discontinuity of the flexure 1002. The mirror 1004 may be configured in the same or similar manner as mirror 222, 504. The mirror 1004 is secured by back plate 1011 and fasteners 1013 (e.g., screws). The fasteners may attach the back plate 1011 to movable support structure 1006. The back plate 1011 may allow for excess heat from the mirror 1004 to be moved along a heat path 1015 such that the excess heat may be dispersed downstream of the heat path 1015.

The movable support structure 1006 may be secured or attached to the housing 1003 of the optical communications terminal at steel pins 1009 by a plurality of fasteners 1014. Like one or more fasteners 514 discussed above, the plurality of fasteners 1014 may be adjusted by tightening or loosening thereof. The adjustment may allow for expansion and contraction of the flexure 1002. In this regard, the plurality of fasteners 1014 may be loosened during expansion allowing for movement of the one or more inner portions of the flexure 1002 in the z direction away from the outer portion. Additionally, the plurality of fasteners 1014 may be tightened during contraction allowing for movement of the one or more inner portions of the flexure 1002 in the z direction towards the outer portion. In some instances, the adjustment of the plurality of fasteners 1014 may be conducted during construction of the optical communications terminal. Additionally or alternatively, in some instances, the adjustment of the plurality of fasteners 1014 may be conducted manually. The adjustment may be conducted based on one or more measures of power and/or intensity of optical beams or signals passing through components of the terminal. The adjustment may be continued until a maximum power and/or intensity of the optical beams is measured. In some instances, the measures of the power and/or intensity of optical beams or signals may be taken by receiver components of the optical communications device (e.g., sensor 138). In some instances, one of the plurality of fasteners 1014 may be adjusted to achieve a desired tip and tilt of the mirror with respect to the other components of the optical communications terminal. Alternatively more than one or all of the plurality of fasteners 1014 may be adjusted to achieve a desired tip and tilt of the mirror with respect to the other components of the optical communications terminal.

Additionally, a plurality of springs 1007 are attached to the movable support structure 1006 and the housing 1003 of the optical communications terminal. The plurality of springs 1007 may be kept in tension. The tension of the plurality of springs 1007 may allow the movable support structure 1006 to also be kept in tension as the plurality of fasteners 1014 are tightened and loosened. In this regard, the tension of the plurality of springs 1007 and the movable support structure 1006 may ensure the flexure 1002, attached to the housing 1003 and the movable support structure 1006, does not expand or compress without the tightening and loosening of the plurality of fasteners 1014.

### EXAMPLE METHODS

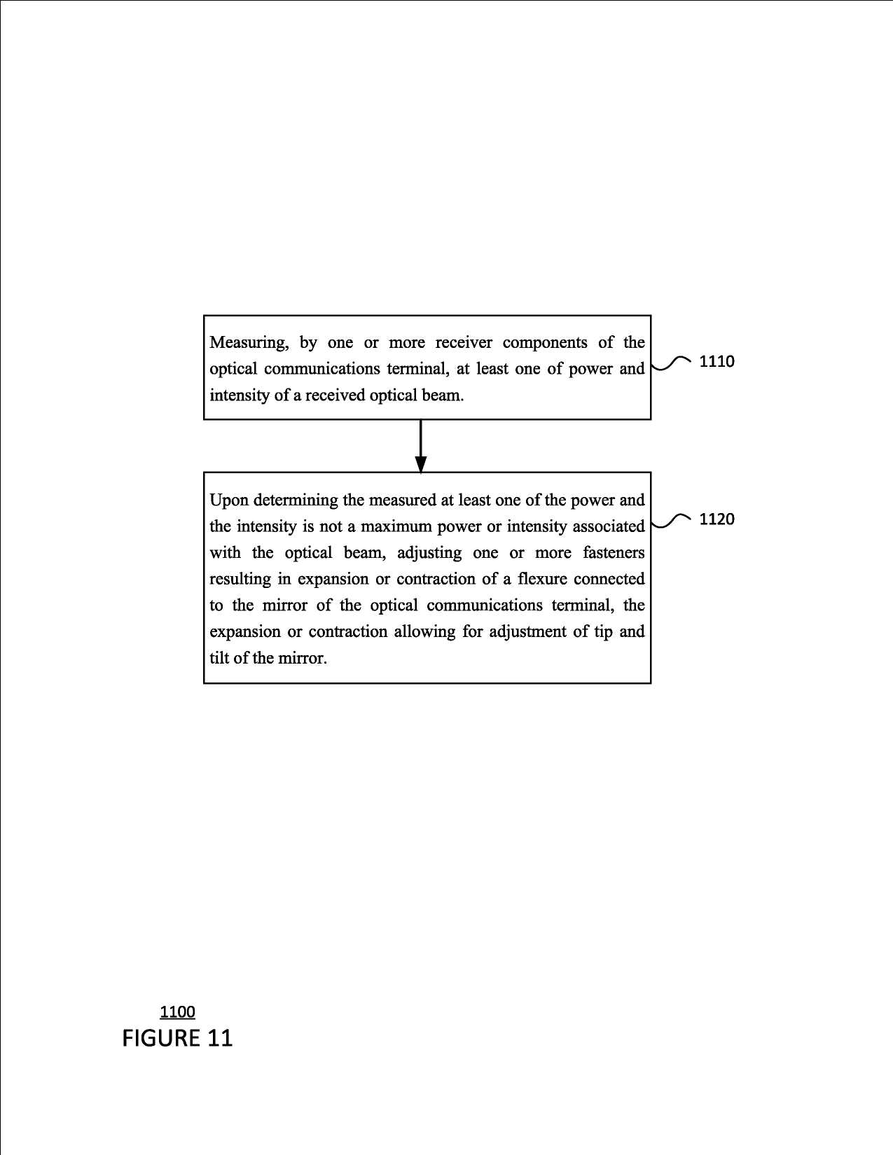

The systems described above may be used in a method of adjusting a mirror of an optical communications terminal. FIG. 11 illustrates an example method 1100 of adjusting a mirror of an optical communications terminal. At block 1110 the method includes measuring, by one or more receiver components of the optical communications terminal, at least one of power and intensity of a received optical beam. The received optical beam may or may not be an optical communications beam. In this regard, the optical beam may be a test beam received by the optical communications terminal (e.g., first optical communications terminal 102, second optical communications terminal 122) in order to determine relative alignment of a mirror (e.g., mirror 222) with other components of the optical communications terminal (e.g., objective lens 210, eyepiece lens 212, relay lenses 214, 216, aperture 224, OPA architecture 114). The maximum possible received power and/or intensity of the test beam may be known. The measures of the power and/or intensity of optical beams or signals may be taken by receiver components of the optical communications device (e.g., sensor 138).

At block 1120, the method further includes upon determining the measured at least one of the power and the intensity is not a maximum power or intensity associated with the optical beam, adjusting one or more fasteners resulting in expansion or contraction of a flexure connected to the mirror of the optical communications terminal, the expansion or contraction allowing for adjustment of tip and tilt of the mirror. In this regard, the maximum possible received power and/or intensity of the test beam may be known. As such, if the maximum possible received power and/or intensity of the test beam, this may be indicative of misalignment of the mirror (e.g., mirror 222). In this regard, one or more fasteners (e.g., one or more fasteners 514, plurality of fasteners 1014, etc.) may be tightened and loosened which may allow for expansion and contraction of the flexure 502, 602, 702, 802, 902, 1002 as discussed above. The expansion and contraction allowing for adjustment of the tip and tilt of the mirror as discussed above. The adjustment of the tip and tilt may allow for alignment of the mirror with the other components of the optical communications terminal such that the maximum possible received power and/or intensity of the test beam may be received by the optical communications terminal. In some instances, the adjustment may be continued until a maximum power and/or intensity of the optical beams is measured.

In some instances, the adjustment of the one or more fasteners may be conducted during construction or manufacture of the optical communications terminal. Additionally or alternatively, in some instances, the adjustment of the one or more fasteners may be conducted manually.

In some instances, the one or more fasteners may be a plurality of fasteners. In such an instance, one of the plurality of fasteners may be adjusted to achieve a desired tip and tilt of the mirror with respect to the other components of the optical communications terminal. Alternatively more than one or all of the plurality of fasteners may be adjusted to achieve a desired tip and tilt of the mirror with respect to the other components of the optical communications terminal.

In some instances, a determination of whether the maximum power and/or intensity of the test beam is received may be conducted manually. Alternatively, the determination may be conducted automatically by one or more processors 104, 124, 203 of the optical communications terminal.

The systems and methodology described herein may allow for alignment of a mirror with other components of an optical communications terminal without need to power up and actuate the mirror. Additionally, the alignment using the flexure may allow for substantially larger changes in tip and tilt than with actuators of the mirror alone. Moreover, flexure may allow for low cost and easily manufacturable components to assist in mirror alignment.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as "such as," "including" and the like, should not be interpreted as limiting the subject matter of the claims to the specific examples; rather, the examples are intended to illustrate only one of many possible embodiments. Further, the same reference numbers in different drawings can identify the same or similar elements.

1. A system for adjustment a mirror of an optical communications terminal, the system comprising:
a mirror configured to direct optical signals between an aperture of the optical communications terminal and an optical phased array (OPA) of an optical communications terminal; and
a flexure configured to receive the mirror, the flexure comprising:
an outer portion,
one or more inner portions, and
one or more discontinuities delineating the one or more inner portions and the outer portion, wherein the one or more discontinuities allow for expansion and contraction of the flexure by movement of the one or more inner portions of the flexure relative to the outer portion of the flexure, wherein expansion and contraction of the flexure allows for adjustment of the mirror.

2. The system of claim 1, further comprising:
a movable support structure attached to the flexure and configured to receive the mirror; and
one or more fasteners configured to attach the movable support structure to a housing of the optical communications terminal, the one or more fasteners being further configured to be adjusted by tightening and loosening, wherein adjustment of the one or more fasteners allows for expansion and contraction of the flexure.

3. The system of claim 2, further comprising
a plurality of springs attached to the movable support structure and the housing of the optical communications terminal, wherein the plurality of springs is kept in tension.

4. The system of claim 3, wherein:
the tension of the plurality of springs allows the movable support structure to be kept in tension; and
the tension of the plurality of springs and the movable support structure prevents the flexure from expanding or compressing unless the one or more fasteners are tightened or loosened.

5. The system of claim 2, further comprising:
a back plate configured to secure the mirror to the movable support structure and the flexure.

6. The system of claim 1, wherein adjustment of the mirror using the flexure is conducted during manufacture of the optical communications terminal.

7. The system of claim 1, further comprising a heat path operatively connected to the mirror, the heat path allowing for downstream dispersal of excess heat from the mirror.

8. The system of claim 1, wherein the flexure expands and contracts in the z direction.

9. The system of claim 1, wherein the one or more discontinuities form a spiral shape.

10. The system of claim 1, wherein the one or more discontinuities form a circular shape.

11. The system of claim 1, wherein the one or more discontinuities form a rectangular shape.

12. The system of claim 1, wherein one of the one or more discontinuities includes a first end located at or adjacent to a connection point between the outer portion of the flexure and the one or more inner portions of the flexure.

13. The system of claim 1, wherein the one or more inner portions includes a first inner portion and a second inner portion separated by at least one of the one or more discontinuities.

14. The system of claim 13, wherein the second inner portion is configured to move relative to the first inner portion and the outer portion during expansion and the contraction of the flexure.

15. The system of claim 1, wherein the one or more inner portions are configured to move away from the outer portion during expansion.

16. The system of claim 1, wherein the one or more inner portions are configured to move towards the outer portion during contraction.

17. A method of adjusting a mirror of an optical communications terminal, the method comprising:
measuring, by one or more receiver components of the optical communications terminal, at least one of power and intensity of a received optical beam; and
upon determining the measured at least one of the power and the intensity is not a maximum power or intensity associated with the optical beam, adjusting one or more fasteners resulting in expansion or contraction of a flexure connected to the mirror of the optical communications terminal, the expansion or contraction allowing for adjustment of tip and tilt of the mirror.

18. The method of claim 17, wherein the adjusting is conducted during manufacture of the optical communications terminal.

19. The method of claim 17, wherein the adjusting is conducted manually.

20. The method of claim 17, wherein adjusting the one or more fasteners includes adjusting a plurality of fasteners.
